(19) United States
(12) Patent Application Publication
(10) Pub. No.: US 2014/0143476 A1
(43) Pub. Date: May 22, 2014

(54) USAGE OF CACHE AND WRITE TRANSACTION INFORMATION IN A STORAGE DEVICE

(71) Applicants: Rotem Sela, Haifa (IL); Avraham Shmuel, Sde Warburg (IL)

(72) Inventors: Rotem Sela, Haifa (IL); Avraham Shmuel, Sde Warburg (IL)

(21) Appl. No.: 13/775,896

(22) Filed: Feb. 25, 2013

Related U.S. Application Data
(60) Provisional application No. 61/727,479, filed on Nov. 16, 2012.

(51) Int. Cl. G06F 12/02

(52) U.S. Cl. CPC G06F 12/0246
USPC 711/103

(57) ABSTRACT

A method and system are disclosed for tracking write transactions in a manner to prevent corruption of file system during interruptions such as power failures between write commands. The method includes the storage device tracking transaction identifiers for write commands and delaying the update of a main memory logical-to-physical map until all of the write commands for a particular transaction have been received based on the transaction ID information. The system includes a storage device having a flash memory with a main logical-to-physical mapping data structure and a controller configured to track individual write commands of a write transaction and store data from those commands without updating the main logical-to-physical mapping data structure until all of the data for the write transaction has been received.

### CROSS-REFERENCE TO RELATED APPLICATIONS

This application claims the benefit of U.S. App. No. 61/727,479, filed Nov. 16, 2012, the entirety of which is hereby incorporated herein by reference.

### TECHNICAL FIELD

This application relates generally to a method and system for managing the storage of data in a data storage device.

### BACKGROUND

Non-volatile memory systems, such as flash memory, are used in digital computing systems as a means to store data and have been widely adopted for use in consumer products. Flash memory may be found in different forms, for example in the form of a portable memory card that can be carried between host devices or as a solid state disk (SSD) embedded in a host device. These memory systems typically work with data units called “pages” that can be written, and groups of pages called “blocks” that can be read and erased, by a storage manager often residing in the memory system.

When data is written to a flash memory, the internal file systems that track the location of data in the flash memory must be updated. Updating data structures for file systems to reflect changes to files and directories may require several separate write operations. Thus, it possible for an interruption between write commands, for example interruptions due to a power failure, to leave data structures for the file system in an invalid state. Detecting and recovering from such a state typically requires a complete walk through of the data structures in the memory device. This must typically be done before the file system is next mounted for read-write access. If the file system is large this can take a long time and result in longer downtimes, particularly if it prevents the rest of the system from coming back online.

One approach to avoiding this situation is to implement a journaling file system. A journaling file system keeps track of the changes that will be made in a separate journal before writing them to the main file system. The journal may be in the form of a circular log in a dedicated area of the file system. In the event of a system crash or power failure, such a file system may be less susceptible to corruption and faster to recover. However, a journaling file system is not generally suitable for a flash storage device because it can prematurely wear out the flash memory.

Accordingly, an alternative way of improving the performance of a file system in a flash memory device during write operations is needed.

### BRIEF SUMMARY

In order to address the problems and challenges noted above, a system and method for handling file system data structure updates in a flash memory system is disclosed.

According to a first aspect, method is disclosed where, in a storage device having a non-volatile memory and a controller in communication with the non-volatile memory, the controller receives a write command that is part of a write transaction from a host. A transaction ID in the write command associated with data in the write command is identified and data from the write command is written to a physical location in the storage device associated with the transaction ID for the write command. Only upon determining that all write commands associated with the transaction ID have been received does the controller then accept the write command. In one implementation the physical location comprises a temporary physical location and accepting the write command consists of moving the data from the write command from the temporary physical location to a final physical location in the non-volatile memory. In another implementation, the storage device includes a main logical-to-physical mapping data structure, writing the data from the write command includes writing the data to the physical location without updating the main logical-to-physical mapping data structure, and accepting the write command includes updating the main logical-to-physical mapping data structure with the location of the data.

According to another aspect, a storage device is disclosed. The storage device includes a non-volatile memory and a controller in communication with the non-volatile memory. The controller is further configured to receive a write command from a host and identify a transaction ID in the write command associated with data in the write command. The controller is also configured to write data from the write command to a physical location in the storage device associated with the transaction ID for the write command and, to accept the write command only upon determining that all write commands associated with transaction ID have been received. In one implementation, the physical location is a temporary physical location and the controller is configured to accept the write command by moving the data from the write command from the temporary physical location to a final physical location in the non-volatile memory. In another implementation the storage device includes a main logical-to-physical mapping data structure, the controller is configured to write the data from the write command to the physical location without updating the main logical-to-physical mapping data structure, and the controller is configured to accept the write command by updating the main logical-to-physical mapping data structure.

Other embodiments are disclosed, and each of the embodiments can be used alone or together in combination. The embodiments will now be described with reference to the attached drawings.

### BRIEF DESCRIPTION OF THE DRAWINGS

FIG. 1 illustrates a block diagram of host and storage device according to one embodiment.

FIG. 2 illustrates an example physical memory organization of the memory in the storage device of FIG. 1.

FIG. 3 shows an expanded view of a portion of the physical memory of FIG. 2.

FIG. 4 is a flow chart of an embodiment of a method of tracking transaction identifiers for each received write command in a write transaction and preventing update of a main mapping table until all data for the transaction has been received.

FIG. 5 illustrates one embodiment of a logical structure for a subordinate logical-to-physical mapping data structure usable to implement the method of FIG. 4.

FIG. 6 illustrates an example of handling interleaved write transactions from a host utilizing the system and method of FIGS. 1 and 4.

### DETAILED DESCRIPTION

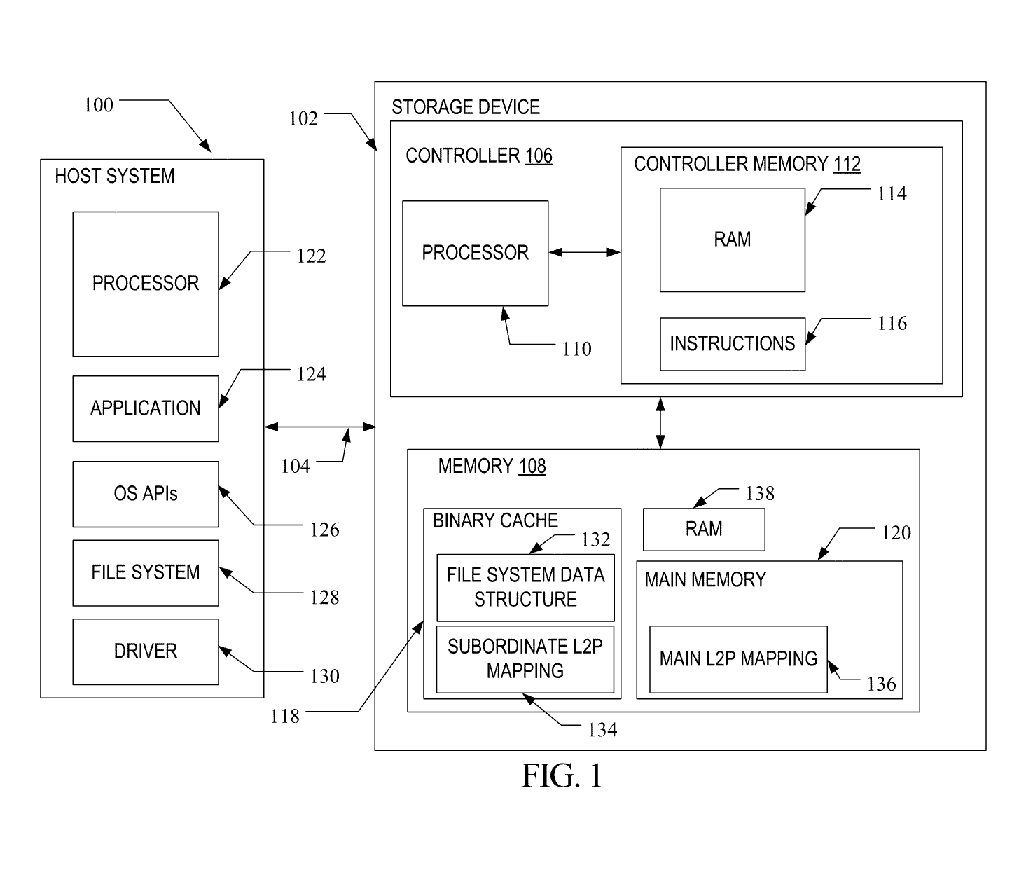

A flash memory system suitable for use in implementing aspects of the invention is shown in FIG. 1. A host system 100 stores data into, and retrieves data from, a storage device 102. The storage device 102 may be embedded in the host system 100 or may exist in the form of a card or other removable drive, such as a solid state disk (SSD) that is removably connected to the host system 100 through a mechanical and electrical connector. The host system 100 may be any of a number of fixed or portable data generating devices, such as a personal computer, a mobile telephone, a personal digital assistant (PDA), or the like. The host system 100 communicates with the storage device over a communication channel 104.

The storage device 102 contains a controller 106 and a memory 108. As shown in FIG. 1, the controller 106 includes a processor 110 and a controller memory 112. The processor 110 may comprise a microprocessor, a microcontroller, an application specific integrated circuit (ASIC), a field programmable gate array, a logical digital circuit, or other now known or later developed logical processing capability. The controller memory 112 may include volatile memory such as random access memory (RAM) 114 and/or non-volatile memory, and processor executable instructions 116 for handling memory management.

As discussed in more detail below, the storage device 102 may include functions for memory management. In operation, the processor 110 may execute memory management instructions (which may be resident in instructions 116) for operation of memory management functions. The memory management functions may control the assignment of the one or more portions of the memory 108 within storage device 102.

The memory 108 may include non-volatile memory (such as flash memory). One or more memory types may be included in memory 108. The memory may include cache storage (also referred to as binary cache) 118 and main memory (also referred to as long term memory) 120 that may be made up of the same type of flash memory cell or different types of flash memory cells. For example, the cache storage 118 may be configured in a single level cell (SLC) type of flash configuration having a one bit per cell capacity while the long term storage 120 may consist of a multi-level cell (MLC) type flash memory configuration having two or more bit per cell capacity to take advantage of the higher write speed of SLC flash and the higher density of MLC flash. Different combinations of flash memory types are also contemplated for the cache storage 118 and long term storage 120. Additionally, the memory 108 may also include volatile memory such as random access memory (RAM) 138.

The binary cache and main storage of memory 108 include physical blocks of flash memory that each consists of a group of pages, where a block is a group of pages and a page is a smallest unit of writing in the memory. The physical blocks in the memory include operative blocks that are represented as logical blocks to the file system 128. The storage device 102 may be in the form of a portable flash drive, an integrated solid state drive or any of a number of known flash drive formats. In yet other embodiments, the storage device 102 may include only a single type of flash memory having one or more partitions.

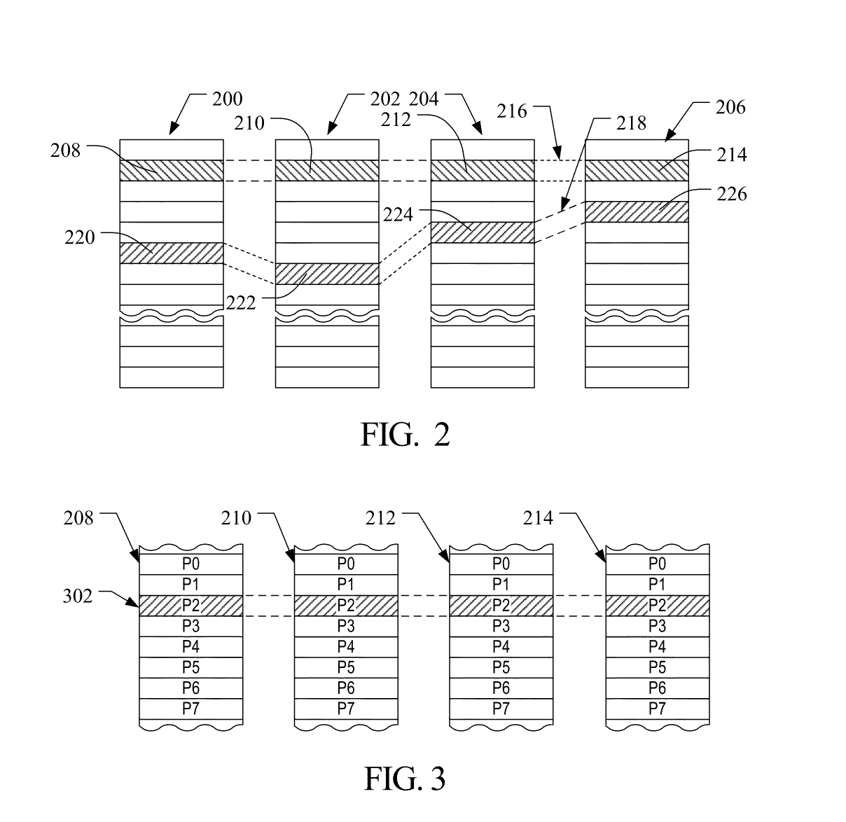

Referring to FIG. 2, the binary cache and main memories 118, 120 (e.g. SLC and MLC flash respectively) may be arranged in blocks of memory cells. In the example of FIG. 2, four planes or sub-arrays 200, 202, 204 and 206 memory cells are shown that may be on a single integrated memory cell chip, on two chips (two of the planes on each chip) or on four separate chips. The specific arrangement is not important to the discussion below and other numbers of planes may exist in a system. The planes are individually divided into blocks of memory cells shown in FIG. 2 by rectangles, such as blocks 208, 210, 212 and 214, located in respective planes 200, 202, 204 and 206. There may be dozens or hundreds of blocks in each plane. Blocks may be logically linked together to form a metablock that may be erased as a single unit. For example, blocks 208, 210, 212 and 214 may form a first metablock 216. The blocks used to form a metablock need not be restricted to the same relative locations within their respective planes, as is shown in the second metablock 218 made up of blocks 220, 222, 224 and 226.

The individual blocks are in turn divided for operational purposes into pages of memory cells, as illustrated in FIG. 3. The memory cells of each of blocks 208, 210, 212 and 214, for example, are each divided into eight pages P0-P7. Alternately, there may be 16, 32 or more pages of memory cells within each block. A page is the unit of data programming and reading within a block, containing the minimum amount of data that are programmed or read at one time. A metapage 302 is illustrated in FIG. 3 as formed of one physical page for each of the four blocks 208, 210, 212 and 214. The metapage 302 includes the page P2 in each of the four blocks but the pages of a metapage need not necessarily have the same relative position within each of the blocks. A metapage is the maximum unit of programming. The blocks disclosed in FIGS. 2-3 are referred to herein as physical blocks because they relate to groups of physical memory cells as discussed above. As used herein, a logical block is a virtual unit of address space defined to have the same size as a physical block. Each logical block includes a range of logical block addresses (LBAs) that are associated with data received from a host 100. The LBAs are then mapped to one or more physical blocks in the storage device 102 where the data is physically stored.

Referring again to FIG. 1, the host 100 may include a processor 122 that runs one or more application programs 124. The application programs 124, when data is to be stored on or retrieved from the storage device 102, communicate through one or more operating system application programming interfaces (APIs) 126 with the file system 128. The file system 128 may be a software module executed on the processor 122 and manages the files in the storage device 102. The file system 128 manages clusters of data in logical address space. Common operations executed by a file system 128 include operations to create, open, write (store) data, read (retrieve) data, seek a specific location in a file, move, copy, and delete files. The file system 128 may be circuitry, software, or a combination of circuitry and software.

Accordingly, the file system 128 may be a stand-alone chip or software executable by the processor of the host 100. A storage device driver 130 on the host 100 translates instructions from the file system 128 for transmission over a communication channel 104 between the host 100 and storage device 102. The interface for communicating over the communication channel may be any of a number of known interfaces, such as SD, MMC, USB storage device, SATA and SCSI interfaces. A file system data structure 132, such as a file allocation table (FAT), may be stored in the memory 108 of the storage device 102. Although shown as residing in the binary cache portion 118 of the memory 108, the file system data structure 132 may be located in the main memory 120 or in another memory location on the storage device 102.

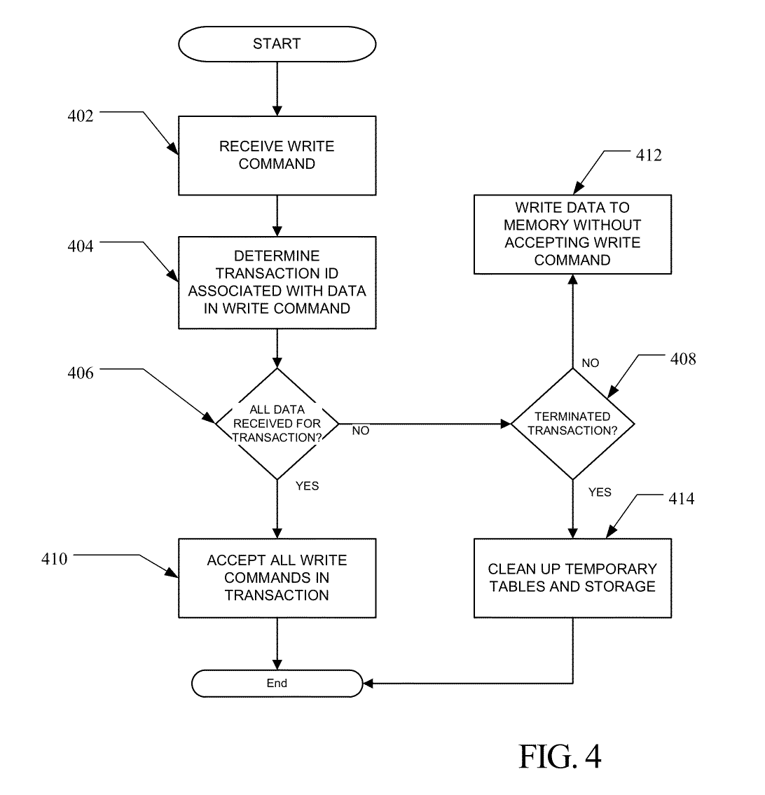

Referring now to FIG. 4, a method of managing write transactions in a storage device, such as storage device 102, is shown. As used herein “write transaction” refers to a set of related write commands received from a host 100. For example, multiple applications 124 may be running on the host 100 and write commands from each application may form respective write transactions where the amount of data the application wishes to store in the storage device 102 necessitates the use of multiple write commands to complete a particular write transaction. In order to track a write transaction, the host 100 provides, and the storage device 102 detects, a transaction ID with each write command. Thus, when the storage device receives a write command (at 402), it looks at the write command to determine the transaction ID that it needs to associate with the data in the write command (at 404). If the storage device has not received all of the write commands carrying data associated with that particular transaction ID (at 406), then, if the storage device does not detect that the transaction has been terminated (at 408), the data in the received write command is written to the storage device 102 without accepting the write command (at 412). If the storage device determines that the received write command is the last one for the transaction ID such that all the data associated with the transaction ID has been received (at 406), then the data in that last write command is also written to the storage device and the controller of the storage device accepts the write command and the prior write commands that were part of the same transaction (at 410).

Alternatively, if the storage device detects a termination of a transaction associated with a transaction ID, the controller 106 of the storage device 102 will then clean up the subordinate logical-to-physical mapping table 134, or other temporary mapping table or entry tracking data for write transactions that have not yet completed, as well as the temporary storage location for data from the incomplete transaction (at 414). The controller 106 may determine that a transaction has been prematurely terminated in a number of ways. In one embodiment, the controller may detect an express “cancel transaction” command from the host 100 as a standalone command or as a flag added to another command from the host. Such a command or flag piggybacked on another command would include the transaction ID for the affected transaction. Alternatively, the controller may detect a termination condition by virtue of a transaction not finishing gracefully, such as not receiving all the expected write commands for the transaction ID or a power down of the storage device in the middle of a transaction. For example, if an error-like situation is detected, the controller may determine that the transaction should be terminated. One such error situation may be the receipt of two “open transaction ID” commands where the transaction ID is the same for both and the first transaction associated with the first open transaction ID command has not yet completed—thus the expected end of the transaction associated with the transaction ID has not been received. Another example of an error that the controller may use to determine a termination condition is receiving a write command that is addressed to an impermissible logical block address (LBA) that would exceed the capacity of the storage device. Any error in the write command itself, or an internal error in the storage device, may be used by the controller to terminate a transaction.

As used herein, to “accept” a command means that the controller 106 of the storage device 102 fully programs the data of the write command and treats it as fully stored in the non-volatile memory 108 of storage device 102. For the controller 106 to accept the one or more write commands associated with a particular write transaction, the controller may move the data from an initial temporary physical storage location to a final physical storage location, may update a main logical-to-physical mapping data structure 136 (e.g., a table, list, etc.) for the storage device with the location of the data in the write command(s), or both. Thus, in embodiments where accepting a write command involves updating a main logical-to-physical mapping data structure, step 408 in FIG. 4 would include writing the data to a physical location without updating the main logical-to-physical mapping data structure until such time as the controller determines that all write commands associated with a write transaction have been received. At that point, at step 410, the controller would accept all the write commands associated with the write transaction by updating the main logical-to-physical mapping data structure with the location of the data from the associated write commands.

In one embodiment, where the memory 108 in the storage device 102 includes a cache 118 and a main memory 120, the step of writing the data in a given write command to the storage device without accepting the write command may include only writing the received data into the cache 118 rather than the main memory 120 until the write transaction is completed, at which point not only will the main mapping table 136 be updated, but the data will be moved from the cache 118 to the main memory 120. In another implementation, the data for an incomplete write transaction may be written to the main memory 120 directly, but the main mapping table 136 is not updated until the controller 106 determines that the write transaction is complete. In yet other embodiments, the initial portion of the memory 108 used to store the data associated with the particular transaction ID until the write transaction is determined to be complete may be a volatile memory such as RAM 138, at which point the data for that transaction ID may be moved either to the non-volatile cache memory 118 or main memory 120. In situations where the controller determines that the incomplete transaction should be terminated, the cache 118 or area of main memory 120 temporarily holding data for the terminated transaction will be freed and the subordinate logical-to-physical mapping table or other entry/table tracking the temporary location of the data for the incomplete and terminated transaction will be updated to show the temporary locations as unused or free to reflect the termination.

The transaction ID that the host 100 includes in each write message may be of any of a number of ID types, depending on the particular protocol being used by the storage device 102. For example, if the storage device and host utilize embedded MultiMediaCard (eMMC) protocols, then the write command may include a code at the end of each write command. Another example of a protocol the storage device and host may be using is the small computer system interface (SCSI) protocol, where the transaction ID could be incorporated into, for example, the command descriptor block (CDB) either in spare bits or in a modified CDB command format. Any of a number of protocols or transaction ID formats may be utilized to implement the transaction ID feature.

In order to determine when all of the write commands, and thus all of the data, associated with a particular transaction ID have been received, the controller 106 may look for a transaction ID completion event that is based on additional information related to or contained in one of the write commands. In one embodiment, the host sends a first write command with a particular transaction ID with information indicating a total number of write commands associated with the transaction ID that will be sent. The controller 106 of the storage device 102 may then determine that all the write commands associated with that transaction ID have been received (i.e. determine that there has been a transaction ID completion event) by maintaining a counter. Each time a write command with the transaction ID is identified, the controller increments (or decrements) the counter until the state of the counter indicates that the number provided in the initial write command has been reached. A separate counter may be kept for each transaction ID that is active. Alternatively, the first write command for a particular transaction ID may include an indication of a total amount of data associated with the transaction ID that is to be sent to the storage device. In this example, the controller tracks the amount of data received that is associated with the transaction ID rather than the number of write commands in making a determination of when a write transaction for the transaction ID is complete.

In other embodiments, the storage device may determine if all the data for a transaction has been received based on a transaction ID completion flag. The transaction ID completion flag may be sent by the host as part of the last write command associated with the particular transaction ID. In this manner, the storage device will keep track of data associated with the particular transaction ID until the flag is received. At that point the controller can update the main logical to physical mapping table 136, move the data from one memory type to another in the storage device, or both. In alternative implementations, the transaction ID complete flag can be sent immediately prior to or immediately following the last write command. Also, the transaction ID complete flag may be part of a message from the host that identifies the transaction ID and notifies the storage device that the transaction is/will be complete, but is sent separately from a write command containing data associated with the transaction ID.

In another implementation, the controller may be configured to identify a transaction ID completion event based simply on receipt of a write command with a transaction ID that differs from the transaction IDs of the prior write commands. In other alternatives, the acceptance of write commands for a transaction may be based on receiving all write commands for more than one transaction ID such that acceptance of one transaction with one ID depends on receipt of all the commands associated with that transaction ID and commands associated with another transaction ID. For example acceptance of the commands for transaction ID “A” may depend on completion of receipt of the write commands for transaction ID “A” as well as receipt of all the commands for transaction ID “B”. Multiple levels of dependencies between different transaction IDs, before a particular write transaction of one particular transaction ID will be accepted, are also contemplated.

Although the main logical-to-physical mapping data structure 136 is not updated until all of the data for a particular transaction ID has been received, the received data is still stored and separately tracked by the controller 106 so that the physical location of the data can be added to the main logical-to-physical mapping table 136 once the write commands for the transaction have all been safely received and the write transaction completed. In one embodiment, the controller 106 tracks the pending write transaction data in a separate data structure, such as a subordinate logical-to-physical mapping data structure 134 that may be a table, linked list or other data structure.

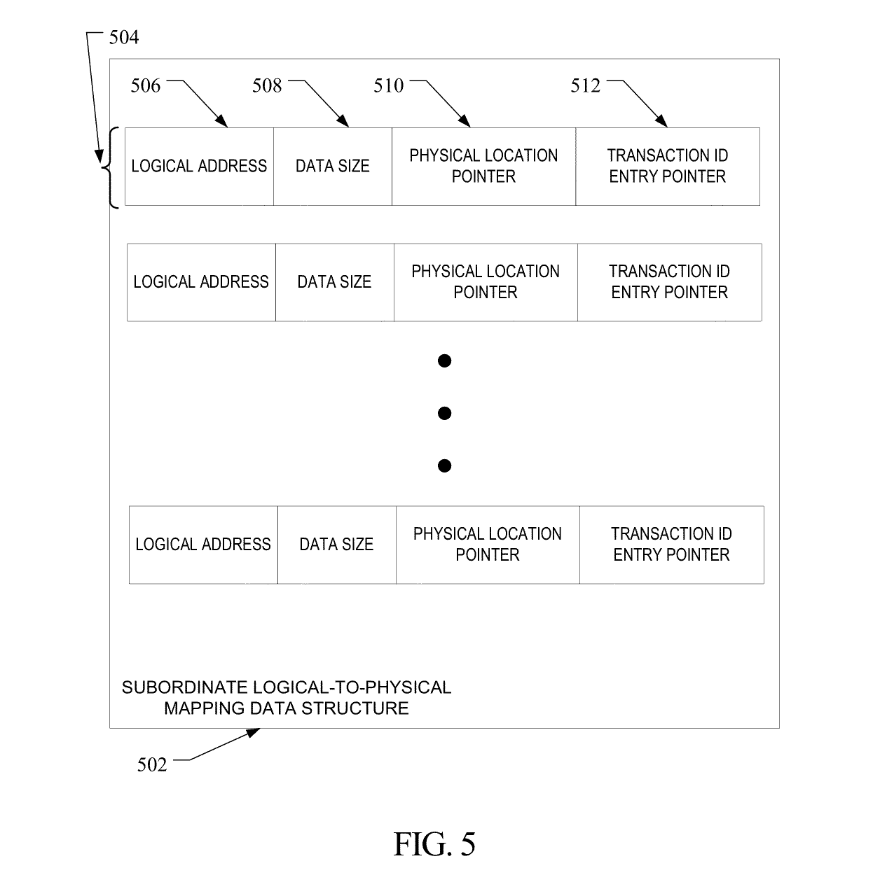

As shown in FIG. 5, the subordinate logical-to-physical mapping data structure 502 may be a list or table of each of the writes for each open write transaction, where each entry 504 in the list associated with a same transaction ID may include the logical address 506 of the data in the write command, the size of the data 508 and a pointer 510 to the current physical location of the data in the memory. The logical address and size information may be provided by the host in the individual write commands, while the pointer 510 is added by the controller of the storage device when the subordinate logical-to-physical mapping data structure 134 entry 504 is generated. Additionally, in one embodiment each entry 504 in the subordinate logical-to-physical mapping data structure 134 may also include a pointer 512 to a next entry associated with the same transaction ID. Once all of the data for a given write transaction has been received, as determined by the transaction ID complete flag or other indicator as discussed above, the controller may then update the main logical-to-physical mapping data structure 136 to point to the physical addresses of the data for the completed write transaction that had been temporarily stored in the subordinate logical-to-physical mapping data structure 134.

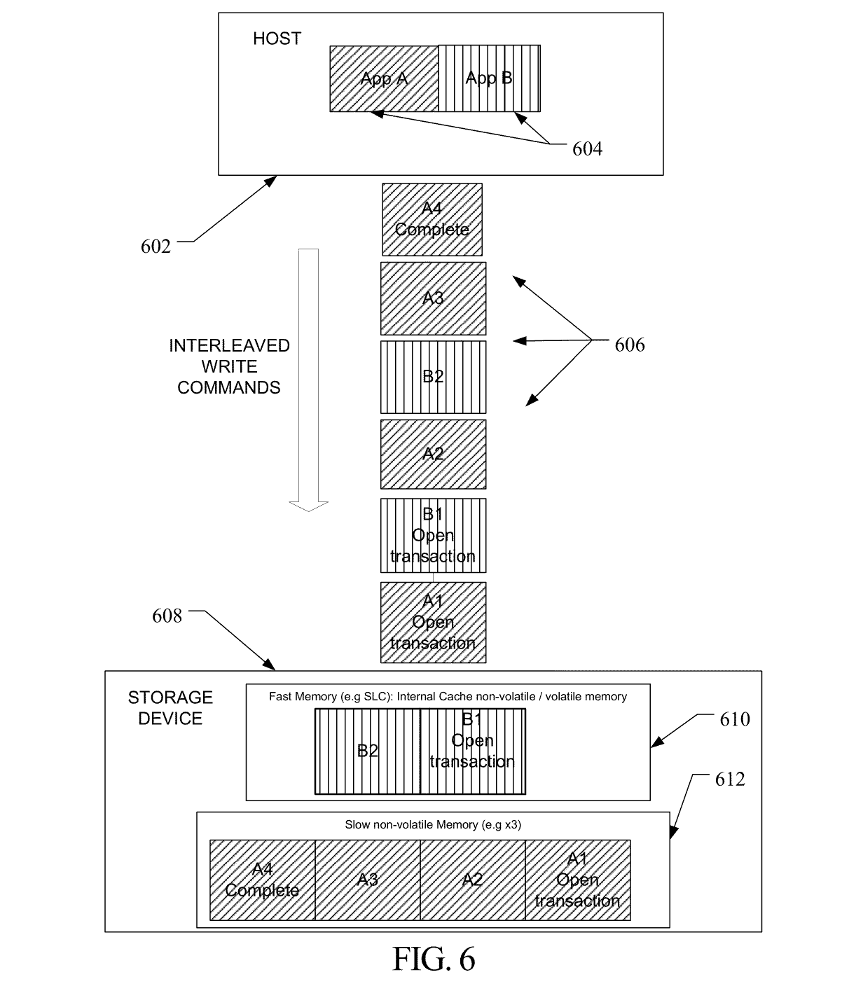

As illustrated in FIG. 6, the host 602 may have more than one host application 604 (e.g. App A and App B) transmitting write commands 606 that form respective write transactions for each of the applications. The write commands 606 for App A (write commands A1-A4) and for App B (write commands B1-B2) may be sent in an interleaved manner by the host 602. A completed write transaction is shown for App A where the write command A4 includes a transaction ID “complete” flag that notifies the storage device 608 that all the data for the App A write transaction has been received. The storage device 608 can update the main logical-to-physical mapping data structure and move the data from App A to main memory 612. In contrast, the write transaction for App B is unfinished such that the data from the write commands is maintained in cache memory 610 and the main logical-to-physical mapping data structure will not be updated. Instead a subordinate logical-to-physical mapping data structure will be used as described above to track the physical location in cache memory 610. During the initial interleaved transmission of write commands from the different applications 604, the write commands are separately tracked by their respective transaction ID, where each write command associated with a different host application is marked by the host and tracked by the storage device by its separate transaction ID. While two write transactions and thus two different transaction IDs are referenced in the example of FIG. 6, any number of concurrent write transactions, each with its own distinct transaction ID, may be managed by this system and method.

In yet other embodiments, the write commands for a particular write transaction may be expected to arrive in an uninterrupted series such that receipt of a write command with a transaction ID that differs from the transaction ID in the last write command may be considered by the controller to be a transaction ID completion event.

The controller 106 of the storage device 102 may be configured to handle certain scenarios of the timing of receipt of write and read commands to avoid corruption or loss of data. In situations where two write commands for different transaction IDs both identify that the data in the different write commands is associated with the same LBA, then the controller may be configured in one of two ways. In one implementation, the controller may be configured to identify this as a termination event and terminate both transactions. In another implementation, the controller may be configured to let the host 100 take care of the overlap by ignoring the overlap and simply updating the main logical-to-physical mapping table 136 for the transaction that closes first. In situations where a read command is received directed to an LBA that is part of an open transaction, the controller 106 may be configured to only return data from the location in main memory 120 identified in the main logical-to-physical mapping table 136 even though updated data exists for that LBA from the in-process write transaction. Alternatively, the controller and storage device may be configured to return the most up-to-date data (i.e. the data associated with the LBA that is part of the incomplete transaction and is stored in temporary storage such as the cache 118) rather than the data at the location recorded at the main logical-to-physical mapping table 136.

A system and method has been disclosed for reducing the likelihood of corrupting a memory by preventing acceptance of write commands for a transaction, for example by preventing the update of a main logical-to-physical mapping data structure for a storage device until all the data associated with a complete write transaction has first been safely received. The method and system tracks a separate transaction ID for each write transaction to verify that all the write commands associated with that write transaction have been safely received before programming the main mapping table with the physical locations of data received in each of the individual write commands for the transaction, or before transferring data from the write commands from a temporary storage location to a final storage location in the memory. An advantage of this system and method is that the regular file system for the host may operate more reliably and safely during power failures.

The methods described herein may be embodied in instructions on computer readable media. “Computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a processor, memory device, computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

It is therefore intended that the foregoing detailed description be regarded as illustrative rather than limiting, and that it be understood that it is the following claims, including all equivalents, that are intended to define the spirit and scope of this invention.

What is claimed is:

1. A method for managing a storage device, the method comprising:
in the storage device operatively coupled with a host, wherein the storage device includes a controller and non-volatile memory, the controller:
receiving a write command from the host;
identifying a transaction ID in the write command associated with data in the write command;
writing data from the write command to a physical location in the non-volatile memory associated with the transaction ID for the write command; and
accepting the write command only upon determining that all write commands associated with the transaction ID have been received.

2. The method of claim 1, wherein the physical location comprises a temporary physical location and accepting the write command comprises moving the data from the write command from the temporary physical location to a final physical location in the non-volatile memory.

3. The method of claim 1, wherein the storage device further comprises a main logical-to-physical mapping data structure, writing the data from the write command further comprises writing the data to the physical location without updating the main logical-to-physical mapping data structure, and accepting the write command comprises updating the main logical-to-physical mapping data structure.

4. The method of claim 1, wherein a first write command associated with the transaction ID includes data indicating a total number of write commands associated with the transaction ID and wherein determining that all the write commands have been received comprises determining if a number of received write commands associated with the transaction ID equals the total number of write commands identified in the first write command.

5. The method of claim 1, wherein a first write command associated with the transaction ID includes data indicating a total amount of data associated with the transaction ID that is to be sent to the storage device and wherein determining that all the write commands have been received comprises determining if an amount of data in received write commands associated with the transaction ID equals the total amount of data identified in the first write command.

6. The method of claim 1, wherein determining that all write commands associated with the transaction ID have been received comprises identifying a transaction ID completion event associated with a command from the host.

7. The method of claim 6, wherein the command is a write command and identifying the transaction ID completion event, comprises receiving a transaction ID completion flag as part of the write command.

8. The method of claim 6, wherein the transaction ID completion event comprises receiving a new transaction ID.

9. The method of claim 1, wherein the non-volatile memory comprises a flash memory having a cache portion and a main storage portion, and wherein writing data received in the write command to the physical location comprises writing data to the cache portion of the non-volatile memory and creating an entry in a subordinate logical-to-physical mapping data structure, separate from a main logical-to-physical mapping data structure, identifying the physical location and transaction ID.

10. The method of claim 1, wherein the storage device further comprises a volatile memory, and wherein writing data from the write command to the physical location comprises writing data to the volatile memory.

11. The method of claim 1, further comprising rejecting any data received in write commands associated with the transaction ID if the transaction associated with the transaction ID is canceled prior to completion of the transaction.

12. The method of claim 1, further comprising rejecting any data received in write commands associated with the transaction ID if a transaction termination condition is detected prior to completion of the transaction.

13. A storage device comprising:
a non-volatile memory;
and
a controller in communication with the non-volatile memory, wherein the controller is configured to:
receive a write command from a host;
identify a transaction ID in the write command associated with data in the write command;
write data from the write command to a physical location in the storage device associated with the transaction ID for the write command; and
accept the write command only upon determining that all write commands associated with transaction ID have been received.

14. The storage device of claim 13, wherein the physical location comprises a temporary physical location and the controller is configured to accept the write command by moving the data from the write command from the temporary physical location to a final physical location in the non-volatile memory.

15. The storage device of claim 13, further comprising a main logical-to-physical mapping data structure, wherein the controller is configured to write the data from the write command to the physical location without updating the main logical-to-physical mapping data structure, and wherein the controller is further configured to accept the write command by updating the main logical-to-physical mapping data structure.

16. The storage device of claim 13, wherein a first write command associated with the transaction ID includes data indicating a total number of write commands associated with the transaction ID and wherein the controller is configured to determine that all write commands have been received if a number of received write commands associated with the transaction ID equals the total number of write commands identified in the first write command.

17. The storage device of claim 13, wherein a first write command associated with the transaction ID includes data indicating a total amount of data associated with the transaction ID that is to be sent to the storage device and wherein the controller is configured to determine that all write commands have been received if an amount of data in received write commands associated with the transaction ID equals the total amount of data identified in the first write command.

18. The storage device of claim 13, wherein the controller is configured to determine that all write commands have been received relating to the transaction ID upon identification of a transaction ID completion event associated with a command received from the host.

19. The storage device of claim 13, wherein the non-volatile memory comprises a cache portion and a main storage portion, and wherein the controller is configured to write data received in the write command to the physical location by writing data to the cache portion of the non-volatile memory and creating an entry in a subordinate logical-to-physical mapping data structure, separate from the main logical-to-physical mapping data structure, identifying the physical location and transaction ID.

20. The storage device of claim 13, wherein the storage device further comprises a volatile memory, and wherein the controller is configured to write data from the write command to the physical location by writing data to the volatile memory and creating an entry in a subordinate logical-to-physical mapping data structure, separate from the main logical-to-physical mapping data structure, identifying the physical location and transaction ID.

21. A method for managing a storage device, the method comprising:
in the storage device operatively coupled with a host, wherein the storage device includes a controller, non-volatile memory and a main logical-to-physical mapping data structure, the controller:
receiving a plurality of write commands from the host;
identifying transaction identifiers (IDs) in the plurality of write commands associated with data in the write command, wherein each write command includes a transaction ID and more than one write command includes a same transaction ID;
writing data from the plurality of write commands to physical locations in the storage device, and tracking a respective transaction identifier associated with the data received in a same write command with the respective transaction identifier, without updating the main logical-to-physical mapping data structure; and
only upon determining that all write commands associated with a same respective transaction ID have been received, updating the main logical-to-physical mapping data structure to include the physical locations of the data associated with the same respective transaction ID.

22. The method of claim 21, wherein receiving the plurality of write commands comprises receiving a first plurality of write commands associated with a first transaction ID and a second plurality of write commands associated with a second transaction ID different than the first transaction ID.

23. The method of claim 22, wherein a first write command associated with the first transaction ID includes data indicating a total number of write commands associated with the first transaction ID and wherein the controller is configured to determine that all write commands associated with the first transaction ID have been received if a number of received write commands associated with the first transaction ID equals the total number of write commands identified in the first write command.

24. The method of claim 22, wherein a first write command associated with the first transaction ID includes data indicating a total amount of data associated with the first transaction ID that is to be sent to the storage device and wherein the controller is configured to determine that all write commands associated with the first transaction ID have been received if an amount of data in received write commands associated with the first transaction ID equals the total amount of data identified in the first write command.

25. The method of claim 22, wherein the controller is configured to determine that all write commands have been received relating to the first transaction ID upon receipt of a transaction ID completion flag associated with the first transaction ID from the host.
